(19) United States
(12) Patent Application Publication
(10) Pub. No.: US 2025/0310002 A1
(43) Pub. Date: Oct. 2, 2025

(54) OPTICAL COMMUNICATION SYSTEM, OPTICAL NODE, AND OPTICAL POWER SUPPLY METHOD

(71) Applicant: NIPPON TELEGRAPH AND TELEPHONE CORPORATION, Tokyo (JP)

(72) Inventors: Akihiro KURODA, Musashino-shi, Tokyo (JP); Tomohiro KAWANO, Musashino-shi, Tokyo (JP); Hidenobu HIROTA, Musashino-shi, Tokyo (JP); Kazuhide NAKAE, Musashino-shi, Tokyo (JP); Hiroshi WATANABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/864,861

(22) PCT Filed: May 27, 2022
(86) PCT No.: PCT/JP2022/021666

§ 371 Date: Nov. 11, 2024

(51) Int. Cl. H04B 10/80; H02J 50/30; H02J 50/40; H02J 50/80

(52) U.S. Cl. CPC H04B 10/807; H02J 50/30; H02J 50/40; H02J 50/80

(57) ABSTRACT

An object of the present invention is to provide an optical communication system, an optical node, and an optical power feeding method capable of managing all of optical nodes by a simple control method.

In an optical communication system 301, a plurality of optical nodes (1-1, 1-2, 1-3, . . . ) is connected in series by optical fibers 16 in a downstream direction from an upstream controller 17, and the controller 17 performs optical power feed to each of the optical nodes (1-1, 1-2, 1-3, . . . ). The optical node 1 includes an optical branching unit 2 that branches a light beam from an upstream side and branches one light beam to a downstream side, a photoelectric conversion element 5 that charges a storage battery 8 with the other light beam branched by the optical branching unit 2, a control unit (microcontroller) 11 that grasps a power storage status of the storage battery 8 when an inquiry signal including an identification code and a power storage answer timing code is included in the other light beam and the identification code is the identification code of the optical node 1, and a modulator 10 that modulates the other light beam and transmits the power storage status to the controller 17 at the time indicated by the power storage answer timing code.

### TECHNICAL FIELD

The present disclosure relates to an optical communication system that performs optical power feed to an optical node, the optical node, and an optical power feeding method thereof.

### BACKGROUND ART

In an optical fiber network, particularly, an access network connecting a communication company and an optical terminal, optical path switching for connecting optical fiber core wires to any route or changing a route is performed at a constant frequency in order to efficiently use equipment in opening and maintenance of the optical fiber network. While such work is normally performed by going to a site to physically change the connection, a technique of remotely performing the work by using an optical switch has been proposed.

For example, Non Patent Literature 1 proposes a system in which a MEMS optical switch is applied to the above-described optical path switching, and operation power of the optical switch is supplied through optical power feed via an optical fiber, which enables power feed to any installation location without a power supply.

In addition, Non Patent Literature 2 reports a technique in which a communication building equipped with a laser and a plurality of optical nodes that remotely operates optical switches are connected by a single optical fiber and controlled. The optical node is equipped with a self-holding optical switch, and one laser enables optical power feed to the plurality of optical nodes and communication with the optical nodes.

### CITATION LIST

### Non Patent Literature

Non Patent Literature 1: R. Helkey et. al., “Remortly powered optical switch for remote subscriber aggregation and OTDR measurement in PON”, 33rd European Conference and Exhibition of Optical Communication (2007)
Non Patent Literature 2: Tomohiro Kawano, Tetsuya Manabe, Akihiro Kuroda, Kazuhide Nakae, Hiroshi Watanabe, and Kazunori Katayama, “Enkaku kouro kirikae node no chokuretsu setsuzoku houshiki ni kansuru ichi kento (in Japanese) (a study on series connection system of remote operated optical fiber switching nodes)” The Institute of Electronics, Information and Communication Engineers General Conference 2022, B-13-28

### SUMMARY OF INVENTION

### Technical Problem

The system described in Non Patent Literature 2 uses optical switches connected in cascade for optical power feed to each optical node and switching of a transmission optical path between a controller and the optical node. Control of switching timing of the optical switches is complicated, and there is a problem of having a difficulty in performing the control with simple control.

In addition, since logical connection between the communication building and the optical node is one-to-one, communication with other optical nodes cannot be performed during communication with a certain optical node, and there is also a problem of having a difficulty in managing excess or deficiency of optical power feed to all the optical nodes.

Further, in a case where the optical switch fails for some reason, there is also a problem of having a difficulty for the controller to control the optical switches below a failure point.

Therefore, to solve the above problems, an object of the present invention is to provide an optical communication system, an optical node, and an optical power feeding method capable of managing all the optical nodes by a simple control method.

### Solution to Problem

To achieve the above object, an optical communication system according to the present invention includes an optical branching unit that branches a light beam at a predetermined branching ratio as an alternative to an optical switch that complicates control.

Specifically, an optical communication system according to the present invention is an optical communication system in which a plurality of optical nodes is connected in series by an optical fiber in a downstream direction from an upstream controller, and the controller performs optical power feed to the optical nodes, in which the optical node includes:

an optical branching unit configured to branch a light beam from an upstream side and output one light beam to a downstream side;

a photoelectric conversion unit configured to charge a storage battery with the other light beam branched by the optical branching unit;

a control unit configured to grasp a power storage status of the storage battery when an inquiry signal including an identification code and a power storage answer timing code is included in the other light beam and the identification code is the identification code of the optical node; and

a modulation unit configured to modulate the other light beam and transmit the power storage status to the controller at time indicated by the power storage answer timing code.

Further, an optical node according to the present invention is an optical node of a plurality of the optical nodes connected in series by an optical fiber in a downstream direction from an upstream controller, and configured to receive optical power feed from the controller, the optical node including:

an optical branching unit configured to branch a light beam from an upstream side and output one light beam to a downstream side;

a photoelectric conversion unit configured to charge a storage battery with the other light beam branched by the optical branching unit;

a control unit configured to grasp a power storage status of the storage battery when an inquiry signal including an identification code and a power storage answer timing code is included in the other light beam and the identification code is the identification code of the optical node; and

a modulation unit configured to modulate the other light beam and transmit the power storage status to the controller at time indicated by the power storage answer timing code.

Moreover, an optical power feeding method according to the present invention is an optical power feeding method performed from an upstream controller to an optical node in an optical communication system in which a plurality of the optical nodes is connected in series by an optical fiber in a downstream direction from the controller, the optical power feeding method including:

in each of the optical nodes,

branching a light beam from an upstream side at an optical branching unit and outputting one light beam to a downstream side;

charging a storage battery of the optical node with the other light beam that has been branched;

grasping a power storage status of the storage battery of the optical node indicated by an identification code when an inquiry signal including the identification code and a power storage answer timing code is included in the other light beam; and modulating the other light beam and transmitting the power storage status to the controller at time indicated by the power storage answer timing code different for each optical node.

The optical branching unit in the optical node always performs optical power feed, so that the controller can always perform optical power feed and optical communication to the plurality of optical nodes.

Since the present optical node does not have an optical switch, there are few failures and complicated control is unnecessary. In addition, the controller instructs information transmission timing from the optical nodes, so that it is possible to collect information (excess or deficiency of the optical power feed) of all the optical nodes without collision.

Therefore, the present invention can provide an optical communication system, an optical node, and an optical power feeding method capable of managing all the optical nodes by a simple control method.

The optical branching unit is capable of varying a branching ratio,

when an adjustment signal including the identification code, a branching ratio instruction code, and an adjustment answer timing code is included in the other light beam, and the identification code is the identification code of the optical node, the control unit adjusts the branching ratio of the optical branching unit to the branching ratio of the branching ratio instruction code, and grasps the power storage status of the storage battery after a predetermined standby time, and

the modulation unit transmits the adjustment of the branching ratio of the optical branching unit to the controller at first time indicated by the adjustment answer timing code, and transmits the power storage status of the storage battery to the controller at second time indicated by the adjustment answer timing code.

In this configuration, optical feed power can be distributed according to a situation of each optical node by adjusting the branching ratio of a branching ratio variable branching unit.

### Advantageous Effects of Invention

The present invention can provide an optical communication system, an optical node, and an optical power feeding method capable of managing all the optical nodes by a simple control method.

That is, according to the present invention, in a system including a monitoring control device installed in a power supply environment and a single or a plurality of optical nodes remotely arranged, it is possible to simultaneously implement optical power feed and an optical communication function to a plurality of optical path switching nodes with a single laser, and to provide a stable optical node system.

### BRIEF DESCRIPTION OF DRAWINGS

FIG. 1 is a diagram for describing a configuration of an optical communication system and optical nodes according to the present invention.

FIG. 2 is a timing chart for describing an optical power feeding method according to the present invention.

FIG. 3 is a diagram for describing a configuration of an optical communication system and optical nodes according to the present invention.

FIG. 4 is a timing chart for describing an optical power feeding method according to the present invention.

FIG. 5 is a flowchart for describing an optical power feeding method according to the present invention.

FIG. 6 is a flowchart for describing an optical power feeding method according to the present invention.

### DESCRIPTION OF EMBODIMENTS

Embodiments of the present invention will be described with reference to the accompanying drawings. The embodiments to be described below are examples of the present invention, and the present invention is not limited to the embodiments to be described below. Note that components having the same reference numerals in the present specification and the drawings indicate the same components.

### First Embodiment

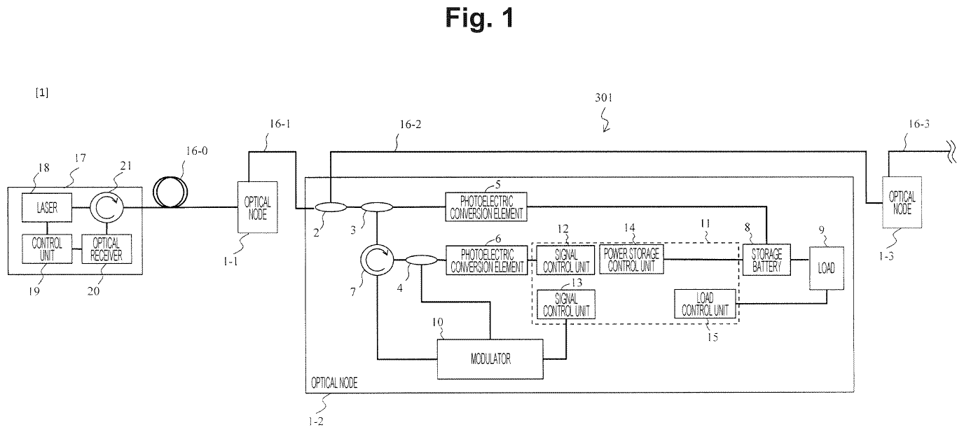

FIG. 1 is a diagram for describing a configuration of an optical communication system 301 and optical nodes 1 according to the present invention.

In the optical communication system 301, a plurality of optical nodes (1-1, 1-2, 1-3, . . . ) is connected in series by optical fibers 16 in a downstream direction from an upstream controller 17, and the controller 17 performs optical power feed to each of the optical nodes (1-1, 1-2, 1-3, . . . ).

Note that, in the present specification, when individual optical nodes are described, they are distinguished by being denoted by reference numerals of 1-1, 1-2, 1-3, . . . , and the like, and when content common to all the optical nodes is described, they are described as “optical node(s) 1”. Similarly, when individual optical fibers are described, they are distinguished by being denoted by reference numerals of 16-0, 16-1, 16-2, 16-3, . . . , and the like, and when content common to all the optical fibers is described, they are described as “optical fiber(s) 16”. In addition, in the present specification, a direction of the controller 17 is referred to as “upstream”, and a direction toward the optical node 1-1, the optical node 1-2, the optical nodes 1-3, . . . is referred to as “downstream”.

The optical node 1 includes:

an optical branching unit 2 that branches a light beam from an upstream side and branches one light beam to a downstream side;

a photoelectric conversion element 5 that charges a storage battery 8 with the other light beam branched by the optical branching unit 2;

a control unit (microcontroller) 11 that grasps a power storage status of the storage battery 8 when an inquiry signal including an identification code and a power storage answer timing code is included in the other light beam and the identification code is the identification code of the optical node 1; and

a modulator 10 that modulates the other light beam and transmits the power storage status to the controller 17 at the time indicated by the power storage answer timing code.

The controller 17 includes a control unit 19, a power feed laser 18, an optical circulator 21, and an optical receiver 20, and is installed in a communication building where power supply can be secured.

The first optical node 1-1 is connected to the controller 17 via the optical fiber 16 0. The second optical node 1-2 is connected to the first optical node 1-1 via the optical fiber 16-1. Similarly, the downstream optical node (1-3 or a subsequent optical node) is also connected to the upstream optical node 1 via the optical fiber (16-2 or the subsequent optical fiber).

The microcontroller 11 includes a power storage control unit 14, a downlink signal control unit 12, an uplink signal control unit 13, and a load control unit 15 that controls a load 9 driven in the optical node 1.

The first optical branching unit 2 branches a downlink light beam from the upstream, and outputs one light beam to the downstream side and the other light beam to a second optical branching unit 3 as imparted light beam. The second optical branching unit 3 branches the imparted light beam, converts one light beam of the imparted light beam into power by the first photoelectric conversion element 5, and the storage battery 8 stores the power. The storage battery 8 supplies the stored power as driving power to all the loads 9 included in the optical node 1.

As described above, since the optical node 1 includes the optical branching unit 2 instead of an optical switch, the storage battery 8 can always store power as long as a light beam is supplied from the upstream.

The other light beam of the imparted light beam branched by the second optical branching unit 3 reaches a third optical branching unit 4 via an optical circulator 7 and is further branched. One light beam of the branched light beam is converted into power by a second photoelectric conversion element 6, and is input to the downlink signal reception control unit 12 of the microcontroller 11.

The other light beam of the light beam branched by the third optical branching unit 4 is supplied to the modulator 10. The uplink signal transmission control unit 13 of microcontroller 11 notifies the modulator 10 of information (for example, a storage amount of the storage battery 8), and the modulator 10 modulates the supplied light beam with the information and outputs the modulated light beam as an uplink signal (answer signal to be described below) to the controller 17.

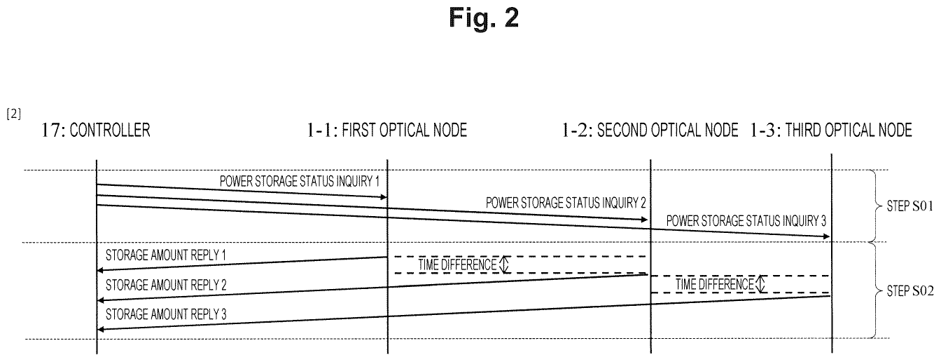

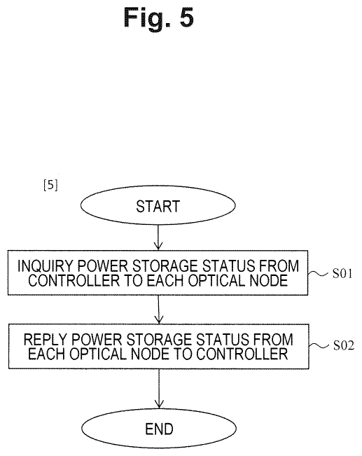

Next, a method in which the controller 17 grasps the storage amount of each optical node 1 will be described. FIG. 5 is a flowchart for describing a storage amount grasping method performed by the controller 17. Further, FIG. 2 is a timing chart for describing communication between the controller 17 and the optical node 1.

The controller 17 transmits a signal (power storage status inquiry) inquiring of each optical node 1 the power storage status (step S01). For example, the controller 17 can generate the power storage status inquiry by modulating the power feed light beam output from the power feed laser 18. The power storage status inquiry signal includes an optical node identification code designating a target optical node and an answer timing code. Each optical node 1 selects the power storage status inquiry signal from the controller 17 on the basis of the optical node identification code. The answer timing code includes transmission time at which each optical node 1 transmits the answer signal to the controller 17. Each optical node 1 transmits the answer signal at the transmission time, thereby avoiding duplication of the answer signal on one optical fiber 16. The answer signal includes a voltage value that is the power storage status of the storage battery 8 inquired of each optical node 1 by the controller 17.

As described above, in the present invention, the power feed light beam (including the storage amount inquiry) supplied from the controller 17 to the optical node 1 is transmitted through the single optical fiber 16 and supplied to each optical node 1 by the first optical branching unit 2 in the optical node 1. Each optical node can always perform optical power feed and receive the storage amount inquiry from the controller 17. That is, the controller 17 can always perform optical power feed and optical communication to the plurality of optical nodes 1.

Note that, regarding a branching ratio of the first optical branching unit 2, a different branching ratio can be set for each optical node 1 in consideration of a transmission loss between the optical nodes 1, or the same branching ratio can be set for all the optical nodes 1.

### Second Embodiment

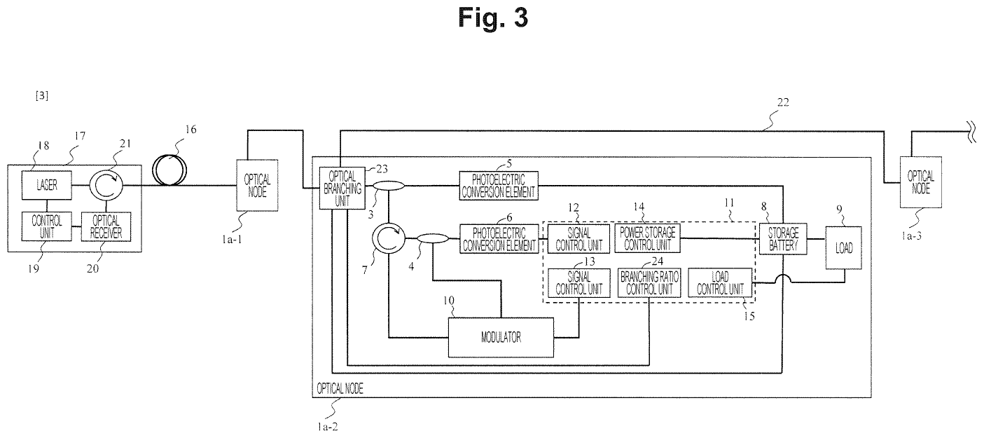

FIG. 3 is a diagram for describing a configuration of an optical communication system 302 and optical nodes 1a according to the present invention. The optical communication system 302 has a configuration in which the first optical branching unit 2 of the optical communication system 301 in FIG. 1 is replaced with a branching ratio variable optical branching unit 23 capable of changing a branching ratio.

That is, the optical communication system 302 is characterized in that, with respect to the optical communication system 301,

the optical branching unit 23 is capable of varying a branching ratio,

when an adjustment signal including the identification code, a branching ratio instruction code, and an adjustment answer timing code is included in the other light beam, a control unit (microcontroller) 11 adjusts the branching ratio of the optical branching unit 23 to the branching ratio of the branching ratio instruction code when the identification code is the identification code of its own optical node, and grasps a power storage status of a storage battery 8 after a predetermined standby time, and

a modulator 10 transmits the adjustment of the branching ratio of the optical branching unit 23 to a controller 17 at first time indicated by the adjustment answer timing code, and transmits the power storage status of the storage battery 8 to the controller 17 at second time indicated by the adjustment answer timing code.

The branching ratio variable optical branching unit 23 is connected to power feed from the storage battery 8 and the branching ratio control unit 24 in the microcontroller 11. The branching ratio variable branching unit 23 is configured by, for example, an automatic branching ratio variable coupler capable of changing the branching ratio by adjusting, with a motor, an inter-core pitch between two optical fibers whose side surfaces are polished.

The branching ratio variable optical branching unit 23 can always receive optical power feed via an optical fiber 16, can communicate with the controller 17, and can adjust optical power feed power to the downstream optical node 1a by arbitrarily changing the branching ratio. The branching ratio control unit 24 of the microcontroller 11 receives the branching ratio adjustment instruction from the controller 17, and adjusts the branching ratio of the branching ratio variable optical branching unit 23 with a control signal. As a result, the optical power feed power can be concentrated on the specific optical node 1a, and a power storage time of the specific optical node 1a can be adjusted.

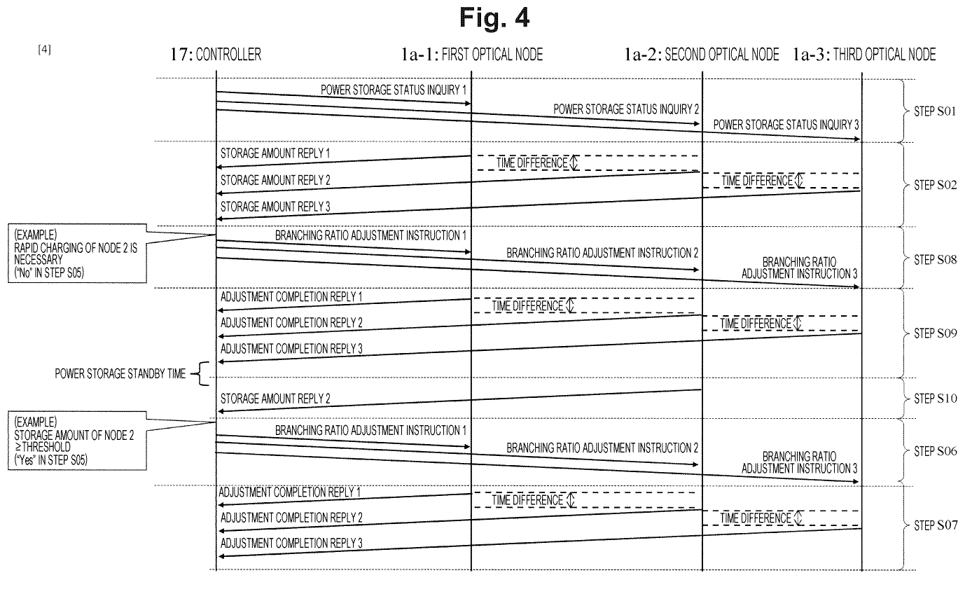

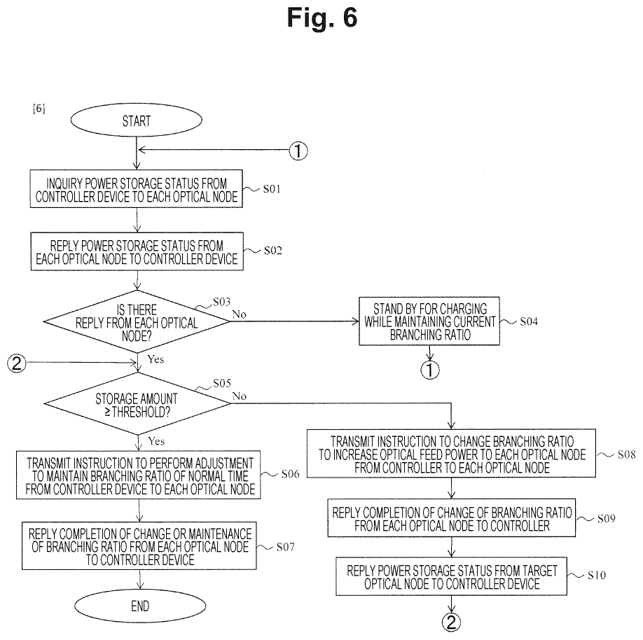

Next, a method in which the controller 17 grasps a storage amount of each optical node 1 and a control method for adjusting the branching ratio will be described. FIG. 6 is a flowchart for describing a storage amount grasping method and a control method performed by the controller 17. Further, FIG. 4 is a timing chart for describing communication between the controller 17 and the optical node 1a. In addition to power storage control communication (steps S01 and S02) described in FIG. 2, the controller 17 performs control communication (steps S03 to S10) for changing the branching ratio of the branching ratio variable optical branching unit 23.

The controller 17 confirms that there is an answer signal from each optical node 1a (step S03). In a case where there is no answer signal from all or a part of the optical nodes 1a (“No” in step S03), the current branching ratio of the branching ratio variable optical branching unit 23 is maintained (step S04). On the other hand, in a case where there are the answer signals from all the optical nodes 1a (“Yes” in step S03), a threshold and the storage amount are compared (step S05). This threshold is based on a storage amount necessary for the microcontroller 11 to continue to be driven and a storage amount necessary for a load 9 to be driven.

The controller 17 determines that the storage amount of the storage battery 8 is insufficient for the optical node 1a with the storage amount<the threshold (“No” in step S05), and supplies a large amount of the power feed light beam to the optical node 1a in a concentrated manner. Specifically, the controller 17 transmits a branching ratio adjustment instruction signal to each optical node (step S08). The branching ratio adjustment instruction signal includes the optical node identification code designating the target optical node 1a (optical node 1a-2 in FIG. 4) and the answer timing code. Each optical node 1a selects the branching ratio adjustment instruction signal from the controller 17 on the basis of the optical node identification code. The answer timing code includes time when each optical node 1a transmits a signal replying adjustment completion to the controller 17 (step S09) after the branching ratio of the branching ratio variable optical branching unit 23 is adjusted, and time when the target optical node 1a replies the storage amount to the controller 17 (step S10) after the branching ratio adjustment is completed. By specifying the answer time, duplication of the answer signals on one optical fiber 16 is avoided.

After the branching ratio of the branching ratio variable optical branching unit 23 of the target optical node 1a is changed, after a predetermined time (time during which the storage battery 8 of the target optical node 1a is rapidly charged) elapses, step S05 is performed again.

In a case where all the optical nodes 1a satisfy the storage amount≥the threshold, the controller 17 transmits the branching ratio adjustment instruction for returning the branching ratio of the branching ratio variable optical branching unit to an original state (initial value) (step S06). Each optical node 1a replies, to the controller 17, that the branching ratio of the branching ratio variable optical branching unit 23 has been returned (step S07).

As described above, in a case where the storage amount of the storage battery 8 of any of the optical nodes 1a is less than the threshold, the optical communication system 302 instructs adjustment of the branching ratio of the branching ratio variable optical branching unit 23 of each optical node 1a, thereby temporarily concentrating the optical feed power on the optical node 1a with the storage amount less than the threshold to shorten a charging time. At this time, by setting the optical feed power to the other optical nodes 1a to a value capable of maintaining the storage amount necessary for driving the microcontroller 11, it is possible to monitor and manage the power storage status of the other optical nodes 1a.

As described above, in the present invention, the power feed light beam (including the storage amount inquiry and the branching ratio adjustment instruction) supplied from the controller 17 to the optical node 1a is transmitted through the single optical fiber 16 and supplied to each optical node 1a by the branching ratio variable branching unit 23 in the optical node 1a. Each optical node 1a can always perform optical power feed and receive the storage amount inquiry and the branching ratio adjustment instruction from the controller 17. That is, the controller 17 can always perform optical power feed and optical communication to the plurality of optical nodes 1a, and can control the optical power feed power according to a charging state of each optical node 1a by adjusting the branching ratio of the branching ratio variable branching unit 23 according to the status of each optical node 1a.

### REFERENCE SIGNS LIST

1, 1-1, 1-2, . . . . Optical node
2 Optical branching unit
3 Optical branching unit
4 Optical branching unit
5 Photoelectric conversion element
6 Photoelectric conversion element
7 Optical circulator
8 Storage battery
9 Load device
10 Uplink communication unit (modulator)
11 Microcontroller
12 Downlink signal control unit
13 Uplink signal control unit
14 Power storage control unit
15 Load control unit
16, 16-0, 16-1, 16-2, 16-3, . . . . Optical fiber
17 Controller
18 Laser
19 Control unit
20 Optical receiver
21 Optical circulator
23 Branching ratio variable optical branching unit
24 Branching ratio control unit
301, 302 Optical communication system

1. An optical communication system in which a plurality of optical nodes is connected in series by an optical fiber in a downstream direction from an upstream controller, and the controller performs optical power feed to the optical nodes, wherein
the optical node includes:
an optical branching unit configured to branch a light beam from an upstream side and output one light beam to a downstream side;
a photoelectric conversion unit configured to charge a storage battery with the other light beam branched by the optical branching unit;
a control unit configured to grasp a power storage status of the storage battery when an inquiry signal including an identification code and a power storage answer timing code is included in the other light beam and the identification code is the identification code of the optical node; and
a modulation unit configured to modulate the other light beam and transmit the power storage status to the controller at time indicated by the power storage answer timing code.

2. The optical communication system according to claim 1, wherein
the optical branching unit is capable of varying a branching ratio,
when an adjustment signal including the identification code, a branching ratio instruction code, and an adjustment answer timing code is included in the other light beam, and the identification code is the identification code of the optical node, the control unit adjusts the branching ratio of the optical branching unit to the branching ratio of the branching ratio instruction code, and grasps the power storage status of the storage battery after a predetermined standby time, and
the modulation unit transmits the adjustment of the branching ratio of the optical branching unit to the controller at first time indicated by the adjustment answer timing code, and transmits the power storage status of the storage battery to the controller at second time indicated by the adjustment answer timing code.

3. An optical node of a plurality of the optical nodes connected in series by an optical fiber in a downstream direction from an upstream controller, and configured to receive optical power feed from the controller, the optical node comprising:
an optical branching unit configured to branch a light beam from an upstream side and output one light beam to a downstream side;
a photoelectric conversion unit configured to charge a storage battery with the other light beam branched by the optical branching unit;
a control unit configured to grasp a power storage status of the storage battery when an inquiry signal including an identification code and a power storage answer timing code is included in the other light beam and the identification code is the identification code of the optical node; and
a modulation unit configured to modulate the other light beam and transmit the power storage status to the controller at time indicated by the power storage answer timing code.

4. The optical node according to claim 3, wherein
the optical branching unit is capable of varying a branching ratio,
when an adjustment signal including the identification code, a branching ratio instruction code, and an adjustment answer timing code is included in the other light beam, and the identification code is the identification code of the optical node, the control unit adjusts the branching ratio of the optical branching unit to the branching ratio of the branching ratio instruction code, and grasps the power storage status of the storage battery after a predetermined standby time, and
the modulation unit transmits the adjustment of the branching ratio of the optical branching unit to the controller at first time indicated by the adjustment answer timing code, and transmits the power storage status of the storage battery to the controller at second time indicated by the adjustment answer timing code.

5. An optical power feeding method performed from an upstream controller to an optical node in an optical communication system in which a plurality of the optical nodes is connected in series by an optical fiber in a downstream direction from the controller, the optical power feeding method comprising:
in each of the optical nodes,
branching a light beam from an upstream side at an optical branching unit and outputting one light beam to a downstream side;
charging a storage battery of the optical node with the other light beam that has been branched;
grasping a power storage status of the storage battery of the optical node indicated by an identification code when an inquiry signal including the identification code and a power storage answer timing code is included in the other light beam; and
modulating the other light beam and transmitting the power storage status to the controller at time indicated by the power storage answer timing code different for each optical node.

6. The optical power feeding method according to claim 5, wherein
the optical branching unit is capable of varying a branching ratio, and
the optical power feeding method further includes:
when an adjustment signal including the identification code, a branching ratio instruction code, and an adjustment answer timing code is included in the other light beam, adjusting the branching ratio of the optical branching unit of the optical node indicated by the identification code to the branching ratio of the branching ratio instruction code;
grasping the power storage status of the storage battery of the optical node after a predetermined standby time;
transmitting the adjustment of the branching ratio of the optical branching unit to the controller at first time indicated by the adjustment answer timing code; and
transmitting the power storage status of the storage battery to the controller at second time indicated by the adjustment answer timing code.
